(19) United States
(12) Patent Application Publication
(10) Pub. No.: US 2025/0387295 A1
(43) Pub. Date: Dec. 25, 2025

(54) BEAUTY DEVICE WITH ADJUSTABLE VIBRATION PATTERN

(71) Applicant: APR CO., LTD., Seoul (KR)

(72) Inventors: Jong Chul JI, Seoul (KR); Gyoun Jung LEE, Seoul (KR); Seung Woo PARK, Seoul (KR)

(21) Appl. No.: 19/203,963

(22) Filed: May 9, 2025

Related U.S. Application Data
(63) Continuation of application No. PCT/KR2023/018052, filed on Nov. 10, 2023.

(30) Foreign Application Priority Data
Nov. 16, 2022 (KR) 10-2022-0153568

(51) Int. Cl. A61H 23/02; A47K 7/04

(52) U.S. Cl. CPC A61H 23/0236; A47K 7/04; A61H 2201/5005; A61H 2201/501; A61H 2201/5097

(57) ABSTRACT

A beauty device, which transmits vibration to the skin of a user so as to cleanse the skin or help apply makeup, includes a vibration device configured to transmit vibration to the skin of a user and a vibration control device configured to operate the vibration device in a predetermined vibrating pattern. The vibration device includes a vibration unit, a vibration actuator, a vibration control unit, and a first communication unit. The vibration control device includes a vibration pattern supply unit, a vibration pattern selection unit, and a second communication unit.

### CROSS-REFERENCE TO RELATED APPLICATIONS

This application is a Continuation of International Application No. PCT/KR2023/018052 filed Nov. 10, 2023, which claims priority from Korean Application No. 10-2022-0153568 filed Nov. 16, 2022. The aforementioned applications are incorporated herein by reference in their entireties.

### TECHNICAL FIELD

The present disclosure relates to a beauty device, and more particularly, to a beauty device that transmits vibration to the skin of a user to cleanse the skin or assist with makeup.

### RELATED ART

Skin care refers to an act of applying cosmetics or cleansing products to the skin, receiving a skin massage, or removing foreign substances from the skin, to manage the skin in a clean and beautiful manner. For skin care, recently, a method of uniformly applying a cleansing product to the skin or cleansing the skin using a body cleansing device having a brush that rotates or vibrates has been used. For example, Korean Patent Application Publication No. 10-2017-0099518 and Korean Utility Model Registration No. 20-0489176 disclose a skin cleansing device for cleansing or massaging the skin by rotating a contact unit equipped with a brush that comes into contact with the skin. In addition, Korean Patent Registration No. 10-2324257 discloses a body cleansing device that vibrates a brush unit using a vibration motor or vibrates an ultrasonic head using an ultrasonic vibrator to provide ultrasonic vibration to a user.

As such, with the development of various beauty devices using vibration, the use of home beauty devices has also significantly increased. In order for a user to directly operate a home beauty device to obtain a desired beauty effect, the beauty device must not only be operated in a precise and safe manner, but also be used regularly and consistently for a certain period of time. However, the current development of home beauty devices focuses only on improving the vibration performance, safety, and miniaturization of the beauty device, and does not arouse the user's interest in using the device, which causes users to easily stop using the beauty device. In addition, the beauty device only operates in a manner preset by the manufacturer, and thus, there has been a drawback in that the user may not adjust the vibration pattern as needed.

### PRIOR ART DOCUMENTS

### Patent Documents

(Patent Document 1) Korean Patent Application Publication No. 10-2017-0099518
(Patent Document 2) Korean Utility Model Registration No. 20-0489176
(Patent Document 3) Korean Patent Registration No. 10-2324257

### SUMMARY

An object of the present disclosure is to provide a beauty device that operates in a vibrating pattern desired by a user, so that the user may perform beauty treatment enjoyably and comfortably.

Another object of the present disclosure is to provide a beauty device that may transmit vibration suitable for the user's condition by freely adjusting a vibrating pattern.

Still another object of the present disclosure is to provide a beauty device that may induce long-term use of the beauty device by arousing the user's interest, through adjusting the vibrating pattern according to the user's preference.

In order to achieve the above objects, the present disclosure provides a beauty device comprising:
a vibration device 100 configured to transmit vibration to the skin of a user, the vibration device 100 including a vibration unit 20 mounted on one end of a housing 10 to transmit vibration to the user's skin, a vibration actuator 30 configured to vibrate the vibration unit 20, a vibration control unit 40 configured to generate a vibration control signal based on a vibration signal and drive the vibration actuator 30 according to the vibration control signal, and a first communication unit 50 configured to receive the vibration signal and transmit the vibration signal to the vibration control unit 40; and
a vibration control device 200 configured to operate the vibration device 100 in a predetermined vibrating pattern, the vibration control device 200 including a vibration pattern supply unit 60 configured to provide vibration sources for generating a vibration signal corresponding to a vibrating pattern desired by the user, a vibration pattern selection unit 80 configured to select a desired vibrating pattern from the vibration sources provided by the vibration pattern supply unit 60, and a second communication unit 90 configured to transmit, to the first communication unit 50 of the vibration device 100, a vibration signal corresponding to the vibrating pattern provided by the vibration pattern supply unit 60.

The beauty device according to the present disclosure may operate in a vibrating pattern desired by the user, so that the user may perform beauty treatment enjoyably and comfortably, and may transmit vibration suitable for the user's condition. In addition, the beauty device according to the present disclosure may induce long-term use of the beauty device by arousing the user's interest, through adjusting the vibrating pattern.

### BRIEF DESCRIPTION OF THE DRAWINGS

FIG. 1 is a perspective view illustrating an appearance of a vibration device usable in a beauty device according to an embodiment of the present disclosure.

FIG. 2 is a block diagram for explaining a configuration of a beauty device according to an embodiment of the present disclosure.

FIG. 3 is a view showing a usage state of a beauty device according to an embodiment of the present disclosure.

### DETAILED DESCRIPTION

Hereinafter, the present disclosure will be described in detail with reference to the accompanying drawings. In the following description of the present disclosure, specific explanations of known universal functions or known configurations will be omitted.

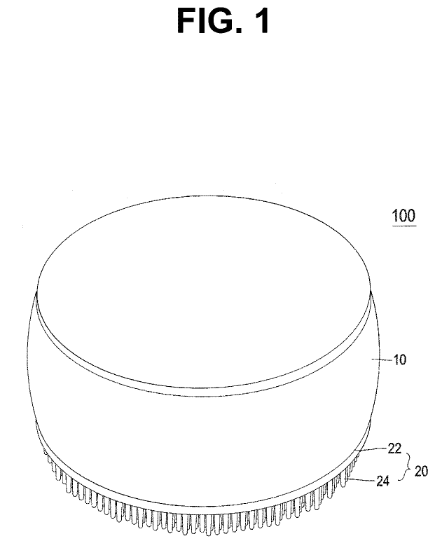

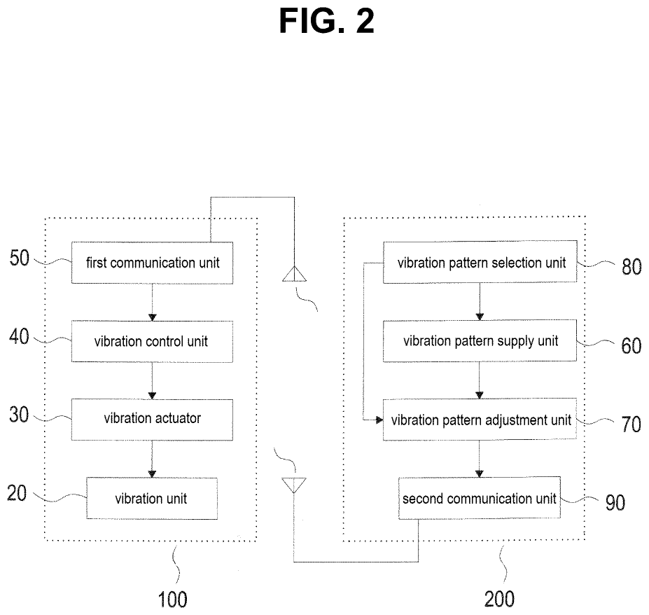

FIG. 1 is a perspective view illustrating an appearance of a vibration device usable in a beauty device according to an embodiment of the present disclosure, and FIG. 2 is a block diagram for explaining the configuration of the beauty device according to an embodiment of the present disclosure. As shown in FIGS. 1 and 2, a beauty device according to an embodiment of the present disclosure includes a vibration device 100 configured to transmit vibration to the skin of a user, and a vibration control device 200 configured to operate the vibration device 100 in a predetermined vibrating pattern. The vibration device 100 includes a housing 10, a vibration unit 20, a vibration actuator 30, a vibration control unit 40, and a first communication unit 50. The vibration control device 200 includes a vibration pattern supply unit 60, a vibration pattern adjustment unit 70, a vibration pattern selection unit 80, and a second communication unit 90.

First, the vibration device 100 usable in the present disclosure will be described. In the vibration device 100 of the present disclosure, the housing 10 may be formed in a generally cylindrical shape so that a user may hold and use the vibration device 100 by hand, and the vibration unit 20 is mounted on one end thereof, and the vibration actuator 30, the vibration control unit 40, and the first communication unit 50 are accommodated inside the housing. The housing 10 may have a form in which one side, to which the vibration unit 20 is coupled, is open and the opposite side is closed, and may be made of a rigid synthetic resin or a synthetic resin having a predetermined elasticity, such as silicone or rubber. When a side surface of the housing 10, which is coupled to the vibration unit 20, is made of a synthetic resin having a predetermined elasticity, it is preferable because the housing 10 absorbs or buffers the vibration of the vibration unit 20.

The vibration unit 20 transmits vibration to the skin of the user, and its edge may be fixed to an end of the open end of the housing 10 so as to cover the open end of the housing 10. The vibration unit 20 may include a vibrating plate 22 that vibrates in a direction perpendicular to its surface, and a skin cleansing unit 24 formed on an upper side of the vibrating plate 22. The skin cleansing unit 24 serves as a medium that contacts the user's skin and massages or cleanses the skin through friction, and may be, for example, a brush, a sponge, a cleansing towel, a cleansing pad, or protrusions, and vibrates together with the vibrating plate 22 to transmit vibration to the skin and thereby perform a massage or cleansing function on the skin surface. As shown in FIG. 1, the vibration unit 20 may have a generally flat shape, or may have an outwardly convex shape so that a portion of the skin cleansing unit 24 more easily contacts the skin. The connection between the vibrating plate 22 of the vibration unit 20 and the housing 10 may be performed by fixing and bonding with a conventional adhesive, bonding with an elastic adhesive such as silicone, physical fitting, or screw coupling.

The vibration actuator 30 is mounted on the vibration unit 20, specifically on the inner surface of the vibrating plate 22 of the vibration unit 20, and vibrates the vibration unit 20 according to a vibration control signal, i.e., an electrical signal, received from the vibration control unit 40. The vibration actuator 30 may generate ultrasonic vibration or mechanical vibration. The ultrasonic vibration may be generated using a piezoelectric element or the like, and the mechanical vibration may be generated by a vibration motor or by an interaction between a coil and a magnet. According to a vibration control signal, which is an electrical signal, applied to the vibration actuator 30, a piezoelectric element, a vibration motor, or a coil/magnet of the vibration actuator 30 vibrates, so that the vibration pattern of the vibration actuator 30 and the vibration unit 20 may be adjusted by controlling an input pattern, frequency, intensity, and the like of the vibration control signal.

The first communication unit 50 receives a vibration signal corresponding to a vibration pattern selected by the user from the vibration control device 200 and transmits the signal to the vibration control unit 40, and the vibration control unit 40 generates a vibration control signal, which is an electrical signal, based on the received vibration signal and drives the vibration actuator 30 according to the vibration control signal. The communication between the first communication unit 50 and the vibration control device 200 may use any conventional communication method such as wired or wireless communication without limitation, but it is preferable to use a wireless communication method such as Wi-Fi or Bluetooth so that the user may operate the vibration device 100 more conveniently.

Next, the vibration control device 200 usable in the present disclosure will be described. In the vibration control device 200 of the present disclosure, the vibration pattern supply unit 60 provides various vibration sources for generating a vibration signal corresponding to a vibrating pattern desired by the user, for example, sound sources. Examples of the vibration sources may include: (i) a cleansing vibration pattern provided by the device manufacturer, (ii) a cleansing vibration pattern edited by the user, (iii) additionally provided vibration cleansing patterns, such as a fine dust cleansing pattern, a sunblock cleansing pattern, or a stress cleansing pattern, and (iv) a cleansing vibration pattern that vibrates according to popular songs listed on a music chart in connection with a music streaming service. The user may select a desired vibration pattern from among the various vibration sources provided by the vibration pattern supply unit 60 through an input device such as the vibration pattern selection unit 80, and, for example, may select and use a vibration pattern from a sound source stored in the vibration pattern supply unit 60 or from a sound source downloaded or streamed via the Internet.

The vibration pattern adjustment unit 70 functions to modify the vibration sources provided by the vibration pattern supply unit 60 according to the needs of the user. For example, when the vibration source selected by the user is a sound source downloaded or streamed via the Internet, the vibration pattern adjustment unit 70 may be a sound filter for extracting low frequencies of 200 Hz or less suitable for a vibration cleanser from the selected vibration source, which is sound source. As such, a vibration pattern obtained by extracting a low-frequency portion from a general music sound source generates a vibration similar to the feeling of listening to the bass part of the selected sound source. In addition, according to the user's need, such as a requirement or preference, input through the vibration pattern selection unit 80, the vibration pattern adjustment unit 70 may mix two or more vibration sources, such as sound waves, provided by the vibration pattern supply unit 60, or may increase or decrease a vibration speed and/or intensity of the vibration source provided by the vibration pattern supply unit 60. If the vibration source provided by the vibration pattern supply unit 60 is used as it is without modification, the vibration pattern adjustment unit 70 may not be used or may not be activated.

The second communication unit 90 transmits a vibration signal corresponding to the vibration pattern provided by the vibration pattern supply unit 60 and/or the vibration pattern adjustment unit 70 to the vibration device 100, specifically, to the first communication unit 50 of the vibration device 100. As described above, the communication between the first communication unit 50 and the second communication unit 90 may use any conventional communication method, such as wired or wireless communication, without limitation, but it is preferable to use a wireless communication method such as Wi-Fi or Bluetooth. The vibration control device 200 may be implemented as any device including the above-described vibration pattern supply unit 60, vibration pattern adjustment unit 70, vibration pattern selection unit 80, and second communication unit 90. For example, the vibration control device 200 may be implemented as a separate controller in the form of a remote controller, or as an application program executed in a mobile device such as a mobile phone. Using the vibration control device 200, two or more vibration devices 100 may be controlled, and each of the two or more vibration devices 100 may be used by a different user so that the users may share the selected vibration.

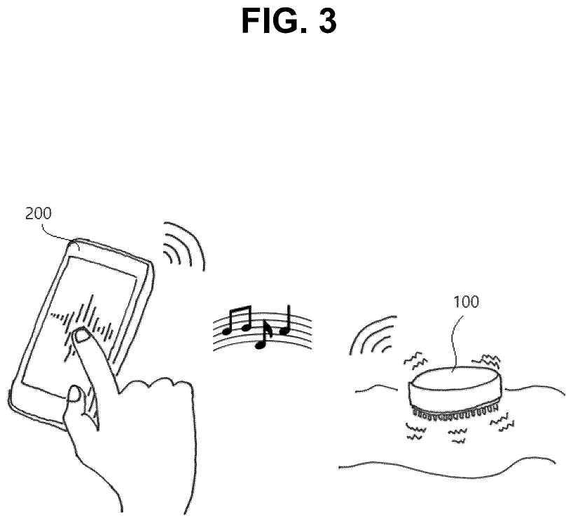

FIG. 3 is a view showing a usage state of the beauty device according to an embodiment of the present disclosure. As shown in FIG. 3, the user controls the vibration control device 200 to select a desired vibration pattern from among various vibration sources provided by the vibration pattern supply unit 60 and, if necessary, modifies the selected vibration source through the vibration pattern adjustment unit 70 and transmits a vibration signal corresponding to the selected vibration pattern to the vibration device 100 through the second communication unit 90. The user holds the vibration device 100 by hand and brings the vibration device 100 into contact with the user's skin, and then operates the vibration device 100 through wireless control or by using an operation switch (not shown) mounted on the vibration device 100, whereby the vibration signal transmitted from the vibration control device 200 is received by the first communication unit 50 of the vibration device 100. The vibration control unit 40 of the vibration device 100 generates a vibration control signal, which is an electrical signal, according to the vibration signal transmitted from the first communication unit 50, and drives the vibration actuator 30 and the vibration unit 20 to transmit vibration to the user's skin, so that the user performs skin care in a vibrating pattern selected by the user.

According to the beauty device of the present disclosure, vibration may be utilized as content by adding a user-desired story to a uniform vibration pattern provided by the manufacturer. The beauty device of the present disclosure is linked with an application via communication such as Bluetooth, and may allow the user to select from among pre-prepared vibrations through the application, and to modify and edit the selected vibration according to the user's needs, and for example, to extract a low frequency from various sources and use it as a vibration pattern. Accordingly, according to the present disclosure, various patterns of vibration may be used, and a user experience-based ecosystem may be established. According to the present disclosure, cleansing vibration patterns that are variously provided and modified may be provided to a plurality of vibration devices 100 so that multiple users may share a specific vibration pattern. In addition, according to the present disclosure, the process of performing beauty treatment at home using the beauty device may be made more enjoyable and comfortable, thereby increasing user satisfaction. The beauty device according to the present disclosure includes various beauty devices that may utilize vibration, and includes, for example, a vibrating body cleanser and a vibrating massager.

Although the present disclosure has been described above with reference to the accompanying drawings and exemplary embodiments, the present disclosure is not limited to the matters shown in the drawings and the above-described embodiments. In the following claims, reference numerals are given for convenience of understanding, but the scope of rights of the claims is not limited to the reference numerals or the content shown in the drawings, and should be interpreted broadly to include modifications, equivalent structures, and functions of the exemplary embodiments.

### INDUSTRIAL APPLICABILITY

The present disclosure relates to a beauty device that transmits vibration to the skin of a user to cleanse the skin or assist with makeup.

What is claimed is:

1. A beauty device comprising:
a vibration device configured to transmit vibration to the skin of a user, the vibration device including a vibration unit mounted on one end of a housing to transmit vibration to the user's skin, a vibration actuator configured to vibrate the vibration unit, a vibration control unit configured to generate a vibration control signal based on a vibration signal and drive the vibration actuator according to the vibration control signal, and a first communication unit configured to receive the vibration signal and transmit the vibration signal to the vibration control unit; and
a vibration control device configured to operate the vibration device in a predetermined vibrating pattern, the vibration control device including a vibration pattern supply unit configured to provide vibration sources for generating a vibration signal corresponding to a vibrating pattern desired by the user, a vibration pattern selection unit configured to select a desired vibrating pattern from the vibration sources provided by the vibration pattern supply unit, and a second communication unit configured to transmit, to the first communication unit of the vibration device, a vibration signal corresponding to the vibrating pattern provided by the vibration pattern supply unit.

2. The beauty device according to claim 1, wherein the vibration control device further comprises a vibration pattern adjustment unit that modifies the vibration sources provided by the vibration pattern supply unit according to a user's need.

3. The beauty device according to claim 2, wherein the vibration pattern adjustment unit is a sound filter that extracts a low frequency of 200 Hz or less from the selected vibration source.

4. The beauty device according to claim 2, wherein the vibration pattern adjustment unit mixes two or more vibration sources provided by the vibration pattern supply unit, or increases or decreases a vibration speed and/or intensity of the vibration source provided by the vibration pattern supply unit.

5. The beauty device according to claim 1, wherein communication between the first communication unit and the vibration control device is performed via Bluetooth wireless communication.
